(19) United States
(12) Patent Application Publication
(10) Pub. No.: US 2025/0118842 A1
(43) Pub. Date: Apr. 10, 2025

(54) BATTERY ENCLOSURE INCLUDING MULTI-FUNCTIONAL, MULTI-LAYERED THERMOPLASTIC COMPOSITE LAMINATED STRUCTURE

(71) Applicants: GM GLOBAL TECHNOLOGY OPERATIONS LLC, Detroit, MI (US); SEKISUI Aerospace, Inc., Sumer, WA (US)

(72) Inventors: David A. OKONSKI, Waterford, MI (US); Mary GILLIAM, Farmington Hills, MI (US); Selina Xinyue ZHAO, Rochester Hills, MI (US); Blair E. CARLSON, Ann Arbor, MI (US); Scott JAMES, Buckley, WA (US); Daniel MIRANDA, Seattle, WA (US)

(21) Appl. No.: 18/483,658

(22) Filed: Oct. 10, 2023

(51) Int. Cl. H01M 50/231; H01M 50/224; H01M 50/227; H01M 50/229; H01M 50/276; H01M 50/278; H01M 50/28; H01M 50/282

(52) U.S. Cl. CPC H01M 50/231; H01M 50/224; H01M 50/227; H01M 50/229; H01M 50/276; H01M 50/278; H01M 50/28; H01M 50/282

(57) ABSTRACT

A battery enclosure for a battery system includes a reinforcing layer including reinforcing fibers, a shielding layer, and a thermal protection layer. At least one of the reinforcing fibers, the shielding layer, and the thermal protection layer is consolidated using a thermoplastic resin into one of a body and a cover of the battery enclosure. The shielding layer is arranged on one side of the one of the body and the cover and the thermal protection layer is arranged on opposite side of the one of the body and the cover.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery enclosures, and more particularly to battery enclosure including a thermoplastic composite laminated structure.

Electric vehicles (EVs) such as battery electric vehicles (BEVs), hybrid vehicles, and/or fuel cell vehicles include one or more electric machines and a battery system including one or more battery cells, modules and/or packs. A battery control module is used to control charging and/or discharging of the battery system during charging and/or driving.

The battery modules and/or battery packs are arranged in enclosures that are typically made of metal such as steel or aluminum. In addition to providing structural support functions, the enclosures may also need to perform other functions such as thermal insulation, fire resistance, and/or electromagnetic shielding. When the structural components are made using aluminum or steel, the structural components may be relatively heavy.

### SUMMARY

A battery enclosure for a battery system includes a reinforcing layer including reinforcing fibers, a shielding layer, and a thermal protection layer. At least one of the reinforcing fibers, the shielding layer, and the thermal protection layer is consolidated using a thermoplastic resin (either pre-impregnated resin or resin supplied into the mold) into one of a body and a cover of the battery enclosure. The shielding layer is arranged on one side of the one of the body and the cover and the thermal protection layer is arranged on opposite side of the one of the body and the cover.

In other features, the reinforcing fibers include at least one of continuous reinforcing fibers and discontinuous reinforcing fibers. The continuous reinforcing fibers are arranged in planar portions of the one of the body and the cover. The continuous reinforcing fibers are selected from a group consisting of unidirectional tape, nonwoven mat, and directed long fiber melts.

In other features, the discontinuous reinforcing fibers are arranged in at least one of planar and non-planar portions of the one of the body and the cover, and the discontinuous reinforcing fibers comprise chopped unidirectional tape.

In other features, the thermoplastic resin is selected from a group consisting of polyether ether ketone (PEEK), polyether ketone ketone (PEKK), polyphenylene sulfide (PPS), polyether imide (PEI), low melt PEEK (LMPEEK), and combinations thereof. At least one metal portion that is consolidated with the reinforcing fibers, the shielding layer, and the thermal protection layer using the thermoplastic resin.

In other features, the shielding layer is selected from a group consisting of a woven metal mesh, a flexible fabric, a coated veil, a metal sheet, a perforated metal sheet, and a metal-coated fiber-filled material. The body of the battery enclosure further comprises a first metal portion arranged at one end of the body; and a second metal portion arranged at an opposite end of the body. The first metal portion and the second metal portion are consolidated with the reinforcing fibers, the shielding layer, and the thermal protection layer using the thermoplastic resin.

In other features, a third metal portion is arranged along one side of the body. A fourth metal portion is arranged along an opposite side of the body. The third metal portion and the fourth metal portion are consolidated with the reinforcing fibers, the shielding layer, and the thermal protection layer using the thermoplastic resin.

In other features, the body further comprises consolidated ribs extending from the one side of the body to the other side of the body.

A battery enclosure for a battery system includes a reinforcing layer including reinforcing fibers, a shielding layer, and a thermal protection layer. One of the reinforcing fibers in the reinforcing layer are consolidated using thermoplastic resin, the reinforcing fibers in the reinforcing layer and the shielding layer are consolidated using thermoplastic resin, and the reinforcing fibers in the reinforcing layer and the thermal protection layer are consolidated using thermoplastic resin. After consolidation, one of the shielding layer and the thermal protection layer is arranged on one side of a composite core and one of consolidated with and adhered to the composite core.

In other features, the reinforcing fibers include at least one of continuous fibers and discontinuous fibers. The continuous fibers are arranged in planar portions of one of a body and a cover of the battery enclosure, and the continuous reinforcing fibers are selected from a group consisting of unidirectional tape, nonwoven mat, and directed long fiber melts.

In other features, the discontinuous fibers are arranged in at least one of planar and non-planar portions of one of a body and a cover of the battery enclosure, and the discontinuous fibers comprise chopped unidirectional tape.

In other features, the thermoplastic resin is selected from a group consisting of polyether ether ketone (PEEK), polyether ketone ketone (PEKK), polyphenylene sulfide (PPS), polyether imide (PEI), low melt PEEK (LMPEEK), and combinations thereof. At least one metal portion is consolidated with the reinforcing fibers, the shielding layer, and the thermal protection layer using the thermoplastic resin.

In other features, the shielding layer is selected from a group consisting of a woven metal mesh, a flexible fabric, a coated veil, a metal sheet, a perforated metal sheet, and a metal-coated fiber-filled material. A body of the battery enclosure further comprises a first metal portion arranged at one end of the body and a second metal portion arranged at an opposite end of the body. The first metal portion and the second metal portion are consolidated with the reinforcing fibers, the shielding layer, and the thermal protection layer using the thermoplastic resin.

In other features, a third metal portion arranged along one side of the body and a fourth metal portion arranged along an opposite side of the body. The third metal portion and the fourth metal portion are consolidated with the reinforcing fibers, the shielding layer, and the thermal protection layer using the thermoplastic resin. The body includes consolidated ribs extending from the one side of the body to the other side of the body.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a battery cell including cathode electrodes, anode electrodes, and separators;

FIG. 2 is a side cross sectional view of an example of a battery pack including a plurality of battery modules arranged in a battery pack enclosure including a thermoplastic composite laminated structure according to the present disclosure;

FIG. 3 is a perspective view of an example of a battery enclosure manufactured using a multi-layered and multi-functional composite structure according to the present disclosure;

FIG. 4 is a side cross sectional view of an example of the enclosure of FIG. 3;

FIGS. 5 to 8 are partial cross sectional views of examples a portion of the multi-layered and multi-functional composite structure of the battery enclosure; and

FIGS. 9 and 10 are flowcharts of examples of methods for manufacturing the battery enclosure including multi-layered and multi-functional composite structure according to the present disclosure.

In the drawings, reference numbers may be reused to identify similar and/or identical elements.

### DETAILED DESCRIPTION

While enclosures according to the present disclosure are described below in the context of battery enclosures for vehicles, the enclosures can be used for other applications.

The present disclosure relates to multi-layered and multi-functional composite structures providing structural, thermal and/or shielding functions. In some examples, the multi-layered and multi-functional composite structures are used to manufacture enclosures for battery packs or battery modules. In some examples, the enclosures include a cover and a body.

The enclosures provide structural rigidity, improved thermal runaway propagation (TRP) protection, and/or electromagnetic interference (EMI) shielding. In some examples, the body and/or cover of the enclosure are manufactured using a one-step compression molding process that integrates the multi-functional layers. In other examples, the body and/or the cover of the enclosure are manufactured using two or more consolidation steps and/or one or more consolidation steps and one or more surface treatments or adhesive steps.

In some examples, one or more types of reinforcing fibers are selected and arranged in various portions of the body or cover of the enclosure to increase strength in regions providing structural support. Using the multi-layered and multi-functional composite structures enables a significant weight reduction (e.g., the mass of enclosure is reduced by 40% or more as compared to all metal solutions).

In some examples, the enclosure is manufactured using resin such as thermoset resin or thermoplastic resin. When thermoplastic resin is used, the enclosure has greater potential for reclaiming and recycling as compared to composites using thermoset-based resin. In some examples, surface pre-treatment methods can be applied to one or both abutting surfaces to enhance adhesion between the layers and/or a composite core.

In some examples, the body and/or cover of the enclosure are manufactured with structural load bearing members (e.g., I-beams or ribs) molded into the composite layers during the compression molding process. In some examples, the pre-treatment processes (e.g., plasma or flame surface treatments or adhesive steps) are incorporated in-line to enhance adhesion of the functional layers. Automotive applications are enabled by a reduction in mold-close-to-mold-close cycle time.

In some examples, the molding process includes a thermoplastic composite core including continuous fibers, discontinuous fibers, or a mixture thereof. In some examples, the mixture and type of reinforcing fibers are adjusted in different regions of the enclosure for strength and stiffness, as well as capability to flow during molding. In some examples, the reinforcing fibers are pre-impregnated with resin. In some examples, the continuous fibers, discontinuous fibers, or a mixtures thereof include materials such as chopped unidirectional tape, nonwoven mat, and/or directed long fiber melts. Chopped unidirectional tape includes reinforcing fibers attached to or embedded in a substrate or backing layer and thermoplastic resin. In some examples, the chopped unidirectional tape is cut to lengths less than 2″. In some examples, the reinforcing fibers are pre-impregnated with a thermoplastic polymer matrix selected from a group consisting of polyether ether ketone (PEEK), polyether ketone ketone (PEKK), polyphenylene sulfide (PPS), polyether imide (PEI), low melt PEEK (LMPEEK or PAEK (e.g., TC1225 (Toray) and AE250 (Victrex)), and combinations thereof.

In some examples, the thermoplastic composite core includes continuous fibers such as fiber tow in uniform or planar regions and discontinuous fibers in non-uniform or non-planar regions such as channels, ribs, stiffeners, or hat sections. In some examples, the thermoplastic composite core includes a thermoplastic polymer matrix selected from a group consisting of polyether ether ketone (PEEK), polyether ketone ketone (PEKK), polyphenylene sulfide (PPS), polyether imide (PEI), low melt PEEK (LMPEEK), and combinations thereof.

In some examples, portions of the body and/or cover include one or more functional layers. Examples of the functional layers include a thermal protection layer on one side and/or a shielding layer on an opposite side. The thermal protection layer provides thermal and/or fire resistance. The shielding layer provides electromagnetic (EMI) shielding.

In some examples, the functional layers are consolidated in an upstream process or during compression molding of the body or cover of the enclosure. In other examples, the functional layers are bonded to a pre-consolidated thermoplastic composite core using a surface treatment such as flame or plasma or using an adhesive. In some examples, the cover and/or the body of the enclosure are produced in single consolidation step or multiple consolidation steps using a compression molding process. In some examples, the compression molding step is performed using a pressure less than 800 psi and a temperature range between 600° F. and 750° F. In some examples, the thermal protection layer limits heat transfer. For example, when one side of the enclosure is exposed to flame of 950° C. for 5 minutes, the enclosure has a temperature on the opposite side no greater than 370° C.

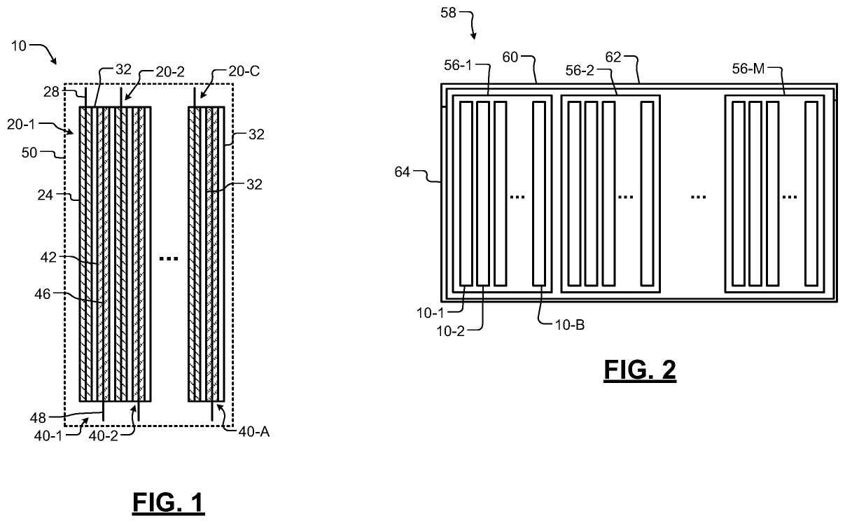

Referring now to FIGS. 1 and 2, a battery cell 10 includes cathode electrodes 20-1, 20-2, . . . , and 20-C, where C is an integer greater than one. The cathode electrodes 20 include a cathode active material layer 24 arranged on one or both sides of cathode current collectors 26. The battery cell 10 includes anode electrodes 40-1, 40-2, . . . , and 40-A, where A is an integer greater than one. The anode electrodes 40 include an anode active material layer 42 arranged on one or both sides of anode current collectors 46. The cathode electrodes 20, the anode electrodes 40 and the separators 32 are arranged in a predetermined order in an enclosure 50 that includes the thermoplastic composite laminated structure. For example, separators 32 are arranged between the cathode electrodes 20 and the anode electrodes 40. External tabs 28 and 48 extend from the current collectors to allow connection of the current collectors to terminals (not shown) of the battery cells. The external tabs 28 and 48 can be arranged on the same side, opposite sides, and/or different sides of the current collectors.

In FIG. 2, a battery pack 58 is arranged in an enclosure 60 including a cover 62 and a body or tray 64. The battery pack 58 includes M battery modules 56-1, 56-2, . . . , and 56-M each including B of the battery cells 10 (e.g., battery cells 10-1, 10-2, . . . , and 10-B), where B and M are integers greater than one.

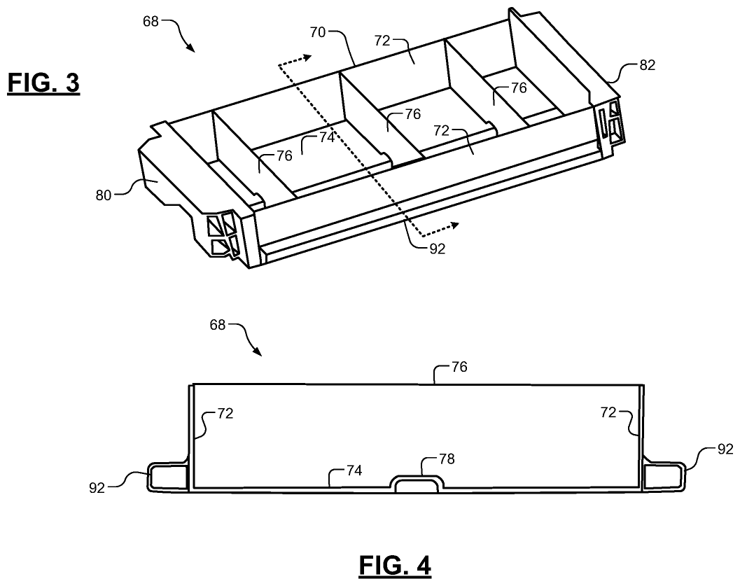

Referring now to FIGS. 3 and 4, a body 68 of an enclosure according to the present disclosure is shown. The body 68 of the enclosure includes a composite core 70 including reinforcing fibers consolidated in a polymer matrix. In this example, the composite core 70 of the enclosure includes side walls 72, a bottom surface 74, and optional dividers 76 (or ribs) extending between the side walls 72. In some examples, a channel 78 is formed on the bottom surface 74 of the composite core 70 to direct vent gases externally.

End walls 80 and 82 of the enclosure are made of metal and are integrated or attached at opposite ends of the composite core 70 during manufacturing as will be described further below. Elongate members 92 are made of metal and extend along lower portions of the side walls 72 and abut and/or are connected to the end walls 80 and 82. In some examples, the elongate members 92 comprise “C”-shaped or “D”-shaped metal box sections.

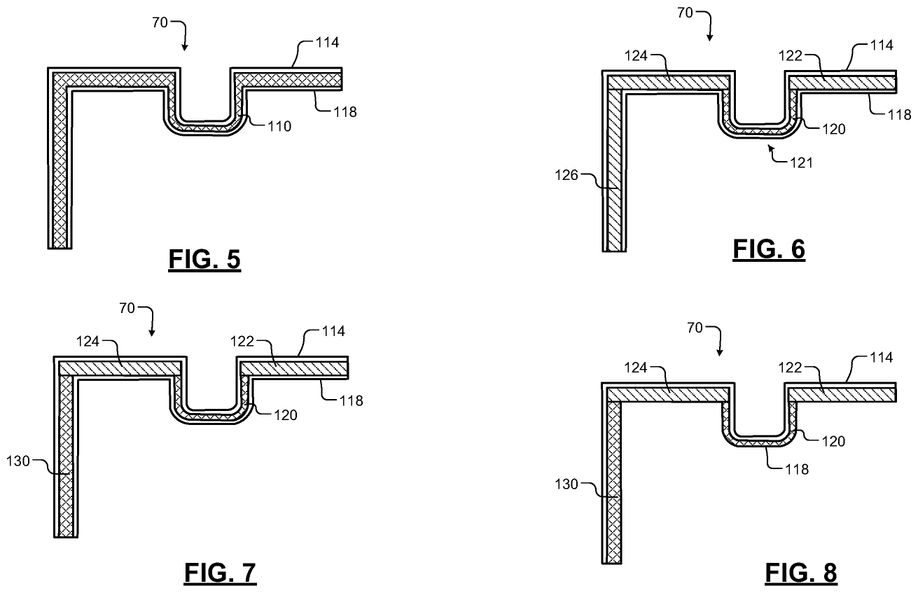

Referring now to FIGS. 5 to 8, examples of portions of the composite core 70 of the body of the enclosure are shown. In FIG. 5, the composite core 70 and the functional layers are consolidated in a single consolidation step. The composite core 70 includes a reinforcing layer 110 comprising reinforcing fibers. The reinforcing fibers include continuous fibers such as fiber tow, chopped unidirectional tape that is consolidated with different fiber orientations, discontinuous fibers, and/or non-woven fiber fleece (e.g., carbon or other reinforcing fibers).

A shielding layer 114 is arranged on one side of the inner layer 110 and consolidated with the composite core 70 during compression molding. In some examples, the shielding layer 114 comprises a shielding material to reduce an electromagnetic interference (EMI). Examples of EMI shielding materials include woven metal mesh that is grounded, a flexible metal fabric (continuous or discontinuous), a coated veil, a metal sheet, a perforated metal sheet, or a metal-coated fiber-filled material.

A thermal protection layer 120 is arranged on the other side of the inner layer 110 and consolidated during compression molding or attached using a surface treatment and/or adhesive. The thermal protection layer 120 comprises thermal material such as insulation or fire retardant material configured to reduce thermal exchange and/or to prevent thermal runaway events. Examples of fire retardant materials include fabric impregnated with fire retardant such as aluminum tetrahydrate (ATH), ammonium polyphosphate (APP), and/or expanding graphite (EG).

In some examples, the composite core 70 in FIG. 5 includes the same type of reinforcing fibers. In other examples, two or more different types of reinforcing fibers are used and/or two or more consolidation steps can be used. In FIGS. 6 and 7, some portions of the composite core 70 are consolidated using different types and/or mixtures of reinforcing fibers to provide different levels of structural support. For example, the enclosure includes both uniformly shaped portions and/or non-uniformly shaped portions. Examples of uniform portions include planar portions. In some examples, continuous reinforcing fibers are used in the planar portions for increased strength. Examples of non-uniformly shaped portions include curved portions, channels, ribs, stiffeners, or hat sections. In some examples, discontinuous reinforcing fibers are used in the non-planar portions when lower structural strength is sufficient (e.g., to reduce cost). After consolidation, the functional layers can be attached using surface treatment or adhesive.

In some examples, uniformly-shaped portions 122, 124 and 126 such as planar portions comprise continuous compression molding (CCM) materials without integrated functional layers such as shielding or fire retardant layers. Examples of the CCM materials include continuous fibers, chopped unidirectional tape that is consolidated with different fiber orientations, discontinuous fibers, and/or non-woven fiber fleece (e.g., carbon or other reinforcing fibers). Non-uniformly shaped portions (e.g., “C”-shaped portion 121) can include chopped unidirectional tape. The portions 121, 122, 124 and 126 are assembled (e.g., using consolidation, surface treatment, and/or adhesive) and the functional layers are added. In FIG. 7, some of the uniform portions (e.g., portion 130) also include the chopped unidirectional tape.

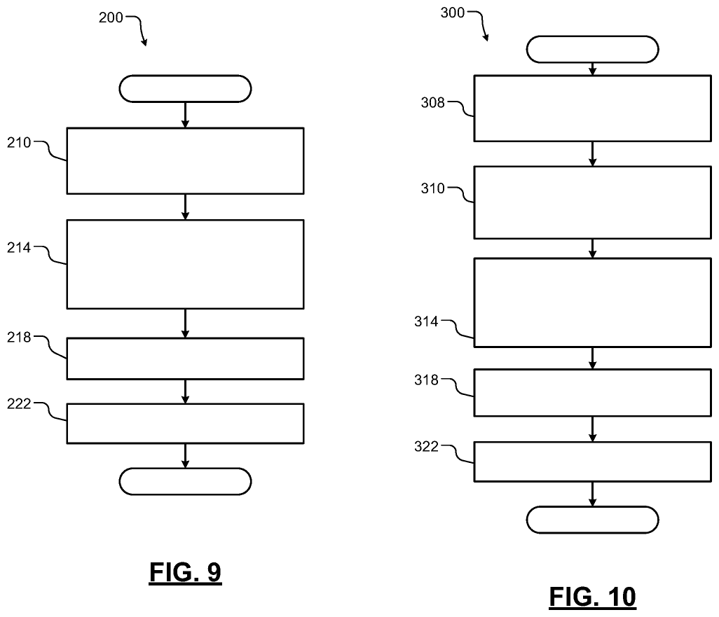

In FIG. 8, the composite core 70 can be consolidated with one functional layer (e.g., the shielding layer 118 or the thermal protection layer 120). If another functional layer is used, it can be added after consolidation using surface treatment and/or adhesive. For example, the thermal protection layer 120 can be integrated with the CCM material during a pre-consolidation step (rather than during a subsequent molding and consolidation process of the enclosure). For example, the shielding layer 118 can be integrated with the CCM material prior to molding and consolidation (rather than during the molding and consolidation process of the enclosure).

Referring now to FIG. 9, a method 200 for manufacturing the enclosures according to the present disclosure is shown. At 210, the metal portions, the shielding layer and/or the thermal protection layer are provided and some may be initially arranged in the compression mold. At 214, one or more types of reinforcing fibers are arranged in the compression mold (in designated structural and non-structural areas) and the remaining ones of the metal portions, shielding layer and fire retardant layer are arranged in the compression mold. At 218, thermoplastic resin is optionally supplied to the mold (e.g., when pre-impregnated fibers are not used). At 222, pressure and/or heat are applied to consolidate the multi-layered and multi-functional composite structure in a single consolidation step.

Referring now to FIG. 10, a method 300 for manufacturing the enclosures according to the present disclosure. At 308, a pre-consolidated core is manufactured. The pre-consolidated core includes reinforcing fibers and thermoplastic resin. The pre-consolidated core can include the shielding layer and/or the thermal/fire retardant layer (or the shielding layer and/or the thermal/fire retardant layer can be attached during a second consolidation step or attached using a surface treatment or adhesive after the first or second consolidation step).

At 310, the metal portions and the pre-consolidated portion are arranged in the compression mold. At 314, one or more of the metal portions and the pre-consolidated portion are arranged in the compression mold, reinforcing fibers are added, and the remaining ones of the metal portions (and optionally the shielding layer and thermal/fire retardant layer) are arranged in the compression mold. At 318, thermoplastic resin is optionally supplied to the mold (e.g., when pre-impregnated fibers are not used). At 322, pressure and/or heat are applied to consolidate the multi-layered and multi-functional composite structure. If the shielding layer and/or the thermal protection layer have not been consolidated, the shielding layer and/or the thermal protection layer can be attached using adhesive or a surface treatment.

Suitable reinforcing fibers include carbon fibers (e.g., carbon black, carbon nanotubes, talc, fibers derived from polyacrylonitrile, cellulosic precursors, and/or pitch precursors), glass fibers (e.g., fiber glass, quartz), basalt fibers, aramid fibers (e.g., poly-para-phenylene terephthalamide, polyphenylene benzobisoxazole (PBO)), and combinations thereof. In some examples, the continuous fibers are arranged in planar portions of the structure and/or discontinuous fibers are arranged in non-planar or irregular portions of the structure.

Compared to metal solutions for battery enclosures, the enclosure described herein offers mass reduction of 40% or greater, part consolidation, reduction in joining methods during battery pack assembly, and the capability of producing each tray and cover in a one-step compression molding process. The enclosure provides structural support, a thermal and flame barrier to manage fire or thermal runaway events. EMI shielding protects the battery system and associated electronics. Regions of the enclosure can be tailored for structural and nonstructural support by varying the reinforcing fibers based on the requirements for crash and safety.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery enclosure for a battery system, comprising:
a reinforcing layer including reinforcing fibers;
a shielding layer; and
a thermal protection layer,
wherein at least one of the reinforcing fibers, the shielding layer, and the thermal protection layer is consolidated using a thermoplastic resin into one of a body and a cover of the battery enclosure,
wherein the shielding layer is arranged on one side of the one of the body and the cover and the thermal protection layer is arranged on opposite side of the one of the body and the cover.

2. The battery enclosure of claim 1, wherein the reinforcing fibers include at least one of continuous reinforcing fibers and discontinuous reinforcing fibers.

3. The battery enclosure of claim 2, wherein:
the continuous reinforcing fibers are arranged in planar portions of the one of the body and the cover, and
the continuous reinforcing fibers are selected from a group consisting of unidirectional tape, nonwoven mat, and directed long fiber melts.

4. The battery enclosure of claim 2, wherein:
the discontinuous reinforcing fibers are arranged in at least one of planar and non-planar portions of the one of the body and the cover, and
the discontinuous reinforcing fibers comprise chopped unidirectional tape.

5. The battery enclosure of claim 1, wherein the thermoplastic resin is selected from a group consisting of polyether ether ketone (PEEK), polyether ketone ketone (PEKK), polyphenylene sulfide (PPS), polyether imide (PEI), low melt PEEK (LMPEEK), and combinations thereof.

6. The battery enclosure of claim 1, further comprising at least one metal portion that is consolidated with the reinforcing fibers, the shielding layer, and the thermal protection layer using the thermoplastic resin.

7. The battery enclosure of claim 1, wherein the shielding layer is selected from a group consisting of a woven metal mesh, a flexible fabric, a coated veil, a metal sheet, a perforated metal sheet, and a metal-coated fiber-filled material.

8. The battery enclosure of claim 1, wherein the body of the battery enclosure further comprises:
a first metal portion arranged at one end of the body; and
a second metal portion arranged at an opposite end of the body,
wherein the first metal portion and the second metal portion are consolidated with the reinforcing fibers, the shielding layer, and the thermal protection layer using the thermoplastic resin.

9. The battery enclosure of claim 8, further comprising:
a third metal portion arranged along one side of the body; and
a fourth metal portion arranged along an opposite side of the body,
wherein the third metal portion and the fourth metal portion are consolidated with the reinforcing fibers, the shielding layer, and the thermal protection layer using the thermoplastic resin.

10. The battery enclosure of claim 9, wherein the body further comprise consolidated ribs extending from the one side of the body to the other side of the body.

11. A battery enclosure for a battery system, comprising:
a reinforcing layer including reinforcing fibers;
a shielding layer; and
a thermal protection layer,
wherein one of:
the reinforcing fibers in the reinforcing layer are consolidated using thermoplastic resin,
the reinforcing fibers in the reinforcing layer and the shielding layer are consolidated using thermoplastic resin, and
the reinforcing fibers in the reinforcing layer and the thermal protection layer are consolidated using thermoplastic resin;
wherein after consolidation, one of the shielding layer and the thermal protection layer is arranged on one side of a composite core and one of consolidated with and adhered to the composite core.

12. The battery enclosure of claim 11, wherein the reinforcing fibers include at least one of continuous fibers and discontinuous fibers.

13. The battery enclosure of claim 12, wherein:
the continuous fibers are arranged in planar portions of one of a body and a cover of the battery enclosure, and
the continuous reinforcing fibers are selected from a group consisting of unidirectional tape, nonwoven mat, and directed long fiber melts.

14. The battery enclosure of claim 12, wherein:
the discontinuous fibers are arranged in at least one of planar and non-planar portions of one of a body and a cover of the battery enclosure, and
the discontinuous fibers comprise chopped unidirectional tape.

15. The battery enclosure of claim 11, wherein is selected from a group consisting of polyether ether ketone (PEEK), polyether ketone ketone (PEKK), polyphenylene sulfide (PPS), polyether imide (PEI), low melt PEEK (LMPEEK), and combinations thereof.

16. The battery enclosure of claim 11, further comprising at least one metal portion that is consolidated with the reinforcing fibers, the shielding layer, and the thermal protection layer using the thermoplastic resin.

17. The battery enclosure of claim 11, wherein the shielding layer is selected from a group consisting of a woven metal mesh, a flexible fabric, a coated veil, a metal sheet, a perforated metal sheet, and a metal-coated fiber-filled material.

18. The battery enclosure of claim 11, wherein a body of the battery enclosure further comprises:
a first metal portion arranged at one end of the body; and
a second metal portion arranged at an opposite end of the body,
wherein the first metal portion and the second metal portion are consolidated with the reinforcing fibers, the shielding layer, and the thermal protection layer using the thermoplastic resin.

19. The battery enclosure of claim 18, further comprising:
a third metal portion arranged along one side of the body; and
a fourth metal portion arranged along an opposite side of the body,
wherein the third metal portion and the fourth metal portion are consolidated with the reinforcing fibers, the shielding layer, and the thermal protection layer using the thermoplastic resin.

20. The battery enclosure of claim 19, wherein the body includes consolidated ribs extending from the one side of the body to the other side of the body.
